(19) United States
(12) Patent Application Publication
(10) Pub. No.: US 2003/0108290 A1
(43) Pub. Date: Jun. 12, 2003

(54) Optical add/drop devices employing waveguide grating-based wavelength selective switches

(76) Inventors: Jianjun Zhang, Cupertino, CA (US); Peiching Ling, San Jose, CA (US); Jinliang Chen, Saratoga, CA (US); Ming Xu, San Jose, CA (US)

Correspondence Address: PERKINS COIE LLP, PATENT-SEA, P.O. BOX 1247, SEATTLE, WA, 98111-1247, US

(21) Appl. No.: 10/202,054

(22) Filed: Jul. 23, 2002

Related U.S. Application Data
(60) Provisional application No. 60/338,927, filed on Dec. 10, 2001.
(60) Provisional application No. 60/346,066, filed on Jan. 3, 2002.
(60) Provisional application No. 60/346,567, filed on Jan. 8, 2002.
(60) Provisional application No. 60/373,803, filed on Apr. 19, 2002.

(51) Int. Cl. G02B 6/34; G02B 6/28

(52) U.S. Cl. 385/37; 385/24

(57) ABSTRACT

This invention relates to optical add/drop devices. These optical add/drop devices are all based on waveguide grating-based wavelength selective switches. Four types of optical switches (S-, L-. X-, and O-type) are disclosed and used to build optical add/drop devices. In addition to the universal advantage of requiring no multiplexers and demultiplexers, each type of switches has its own advantages to build add/drop devices. A simple add/drop device can be made by using only two switches. A large-scale add/drop device can also be built upon same switches. Since the switches are integrated and fabricated on a silicon-based substrate, the size and cost of the add/drop devices are also significantly reduced.

### RELATED APPLICATIONS

Priority is hereby claimed under 35 U.S.C. §120 to U.S. Provisional Patent Application Serial No. 60/338,927 filed Oct. 22, 2001, U.S. Provisional Patent Application Serial No. 60/346,066 filed Jan. 3, 2002, U.S. Provisional Patent Application Serial No. 60/373,803 filed Apr. 19, 2002, U.S. patent application Ser. No. 10/104,273 filed Mar. 22, 2002, and U.S. patent application Ser. No. 10/___,___ filed Jun. 19, 2002, each of which is hereby incorporated by reference.

### BACKGROUND OF THE INVENTION

1. Field of the Invention

This invention relates generally to technologies for switching and routing optical signals, and more particularly, relates to add/drop devices comprising waveguide grating-based wavelength selective switches.

2. Description of the Related Art

Optical wavelength division multiplexing (WDM) is a very important method used in modern optical fiber communication systems to dramatically increase data transmission rate in an optical network. In WDM systems, the data travels on a number of different wavelength optical signals (wavelength channels). Each wavelength channel carries its own data information. Therefore, with WDM technology, a single optical fiber can transmit a number of distinguishable optical signals simultaneously. The result is a significant increase in the effective bandwidth of the optical fiber and data transmitting rate of the communication system.

In the WDM networks of the past, adding, dropping or cross connecting of individual wavelength channels has involved conversion of the optical signal back to the electrical domain. Development of all-optical switches for applications ranging from add-drop functionality to large-scale cross-connects is key to adding intelligence to the optical layer of the optical networking systems. However, with current technical limitations, all fiber network systems implemented with optical switches are still quite expensive.

To employ WDM technology in an optical communication system, optical demultiplexers, switches, multiplexers, and add/drop devices are important. Current state of the art in optical switching and signal transmission systems are limited to optical switching of an entire spectral range without wavelength differentiation or selection. Due to the lack of wavelength selection, an optical switch operation must frequently operate with a wavelength de-multiplexing and multiplexing device to transfer optical signals of different wavelengths to different ports. This requirement leads to more complicated system configurations, higher manufacture and maintenance costs, and lower system reliability. For this reason, even though optical switches provide an advantage that the optical signals are switched entirely in the optical domain without converting them into the electrical domain, the cost and size of application cannot be easily reduced.

An add/drop device is used to inject (add) or extract (drop) one or more wavelength channels to or from a WDM network. Current optical add/drop devices usually consist of various types of optical switches and require optical multiplexers and demultiplexers, as shown in the prior art of FIGS. 1A and 1B. FIG. 1A shows a typical block diagram of an optical add/drop device. Through the optical add/drop device, wavelength channels can be added or dropped to or from the main optical transmission trunk.

FIG. 1B illustrates the construction of a typical prior art optical add/drop device. This optical add/drop device requires a demultiplexer and a multiplexer to carry out wavelength selective switching operations in order to accomplish the add/drop functions. The requirement of a demultiplexer and a multiplexer makes the prior art optical add/drop devices complex and costly to build. For a simple add/drop matrix, this requirement of demultiplexer and a multiplexer is a significant burden. In addition, for a larger add/drop matrix, these prior art optical add/drop devices suffer from their rapidly increasing complexity as the matrix size grows.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1A is a prior art optical add/drop device.

FIG. 1B is a schematic diagram showing a prior art optical add/drop device using a demultiplexer and a multiplexer.

FIGS. 2A and 2B are schematic diagrams showing the on/off switching functions of a Bragg grating wavelength selective bridge waveguide.

FIGS. 3A to 3B are cross sectional views showing the coupling configurations of a wavelength-selective bridge waveguide coupled between a bus waveguide and an outbound waveguide in S-type switches.

FIG. 3C shows an add/drop device according to the present invention constructed using two S-type switches.

FIGS. 4A to 4B are functional diagrams for showing a wavelength selective bridge waveguide coupled between intersecting waveguides for switching and re-directing optical transmission of a selected wavelength using L-type switches.

FIG. 4C shows an add/drop device according to the present invention constructed from two L-type switches.

FIG. 4D shows a symbolic diagram of the structure shown in FIG. 4C.

FIG. 5 shows an X-type switch used as an add/drop device.

FIG. 6A shows an O-type switch disclosed in this invention.

FIG. 6B is a schematic diagrams for showing an optical add/drop device implemented with two O-type switches.

FIG. 6C is a schematic diagrams for showing an optical add/drop device implemented with multiple O-type switches.

FIGS. 7A, 7B, 7C, and 7D are schematic diagrams for showing optical add/drop devices implemented with L-type switches.

FIGS. 8A, 8B, 8C, and 8D are schematic diagrams for showing alternative optical add/drop devices implemented with L-type switches.

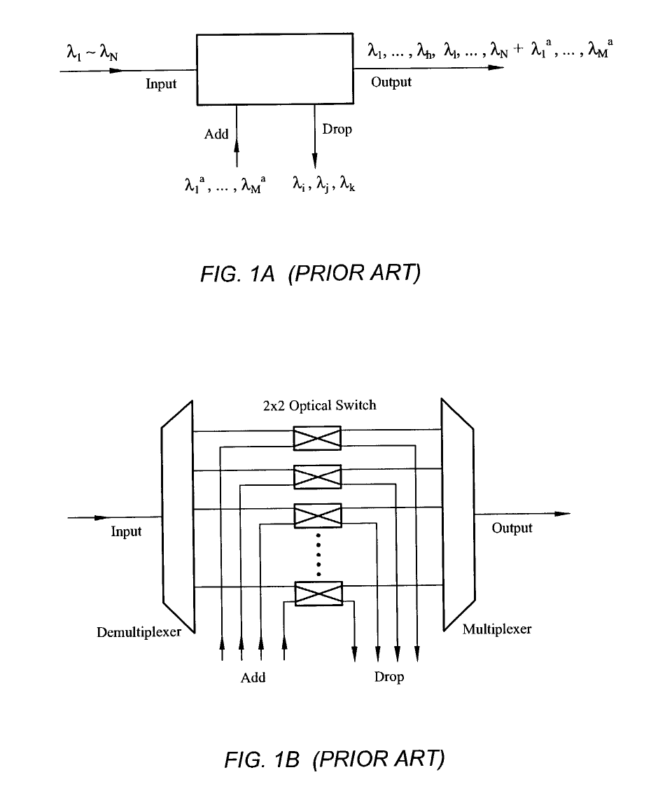

### DETAILED DESCRIPTION OF THE PREFERRED EMBODIMENT

In the following description, numerous specific details are provided, such as the identification of various system components, to provide a thorough understanding of embodiments of the invention. One skilled in the art will recognize, however, that the invention can be practiced without one or more of the specific details, or with other methods, components, materials, etc. In still other instances, well-known structures, materials, or operations are not shown or described in detail to avoid obscuring aspects of various embodiments of the invention. Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present invention utilizes MEMS-actuated waveguide grating-based wavelength intelligent switches as disclosed in our co-pending patent applications noted above. The switch is fabricated on a silicon substrate and the switching action is based on electrostatic bending of a part of waveguide with an integrated Bragg gratings built in its cladding layer. The waveguide with the integrated Bragg gratings, termed as a “bridge waveguide”, functions as a switching element. When the bridge waveguide is electro-statically bent close enough to an input waveguide, the wavelength which meets the Bragg phase-matching condition is coupled into the bridge waveguide. Through the bridge waveguide, the selected wavelength is then directed into a desired output waveguide.

Electrostatic bending of the bridge waveguide can be implemented by applying a voltage between a silicon substrate and an electrode. This can greatly simplify the production of large-scale optical switches, compared with the prior art micro-mirror based MEMS approach. The integrated Bragg grating is formed by physically corrugating a waveguide. Thus, it does not rely upon a photorefractive index change, which enables building Bragg gratings in materials that are not photo-refractive. Further, the integrated Bragg grating can be made smaller, and packed closer together than fiber-optic devices.

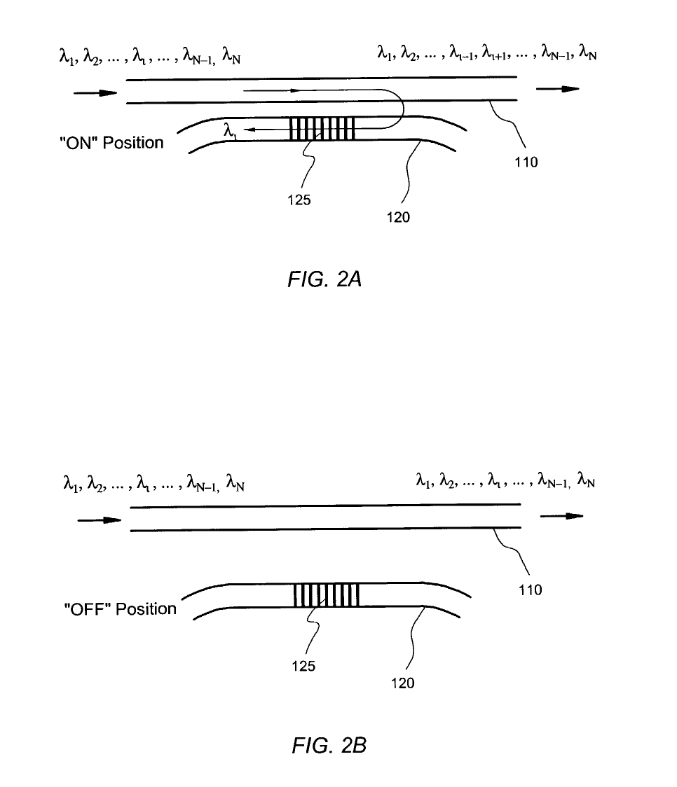

FIGS. 2A and 2B are schematic diagrams showing the on and off states respectively of a wavelength-selective bridge waveguide 120 relative to a multi-channel bus waveguide 110. A multiplexed optical signal is transmitted in a bus waveguide 110 over N multiplexed wavelengths λ₁, λ₂, λ₃, . . . , λ_{N}, where N is a positive integer. In FIG. 2A, the wavelength selective bridge waveguide 120 is moved to an on-position and coupled to the waveguide 110. An optical signal with a central wavelength λᵢ particular to the Bragg gratings 125 disposed on the bridge waveguide 120 is guided into the wavelength selective bridge waveguide 120. The remainder optical signal of the wavelengths λ₁, λ₂, . . . , λᵢ₋₁, λᵢ₊₁, . . . , λ_{N} is not affected and continues to transmit over the waveguide 110. The Bragg gratings 125 have a specific pitch for reflecting the optical signal of the selected wavelength λᵢ onto the wavelength selective bridge waveguide 120. In FIG. 2B, the wavelength selective bridge waveguide is pulled off from the waveguide 110 to a “bridge-off” position. There is no “detoured signal” entering into the bridge waveguide. The entire multiplexed signal over wavelengths λ₁, λ₂, λ₃, . . . , λ_{N} continue to transmit on the bus waveguide 110.

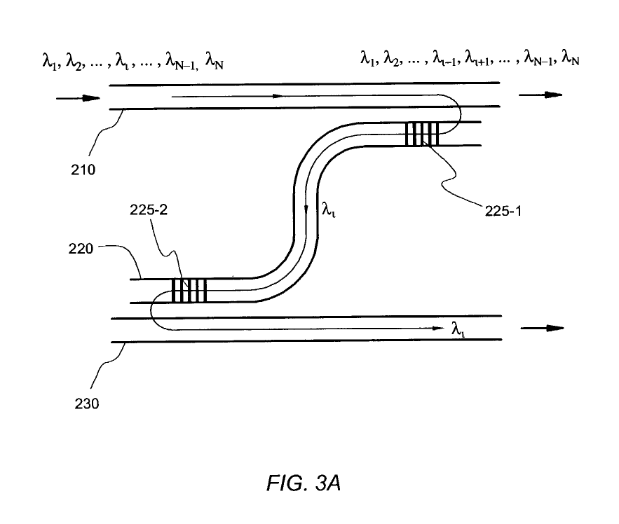

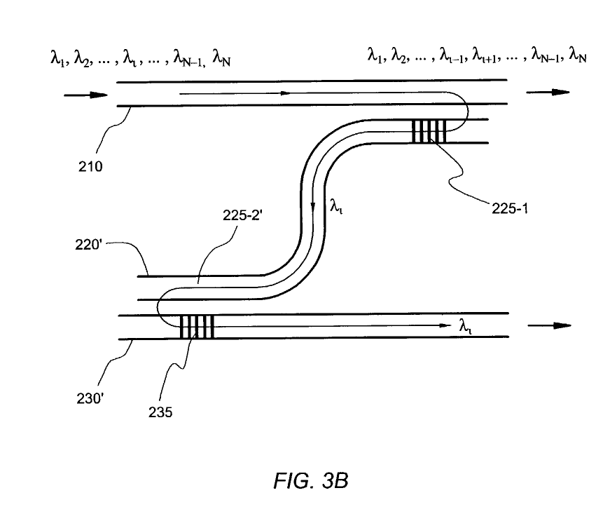

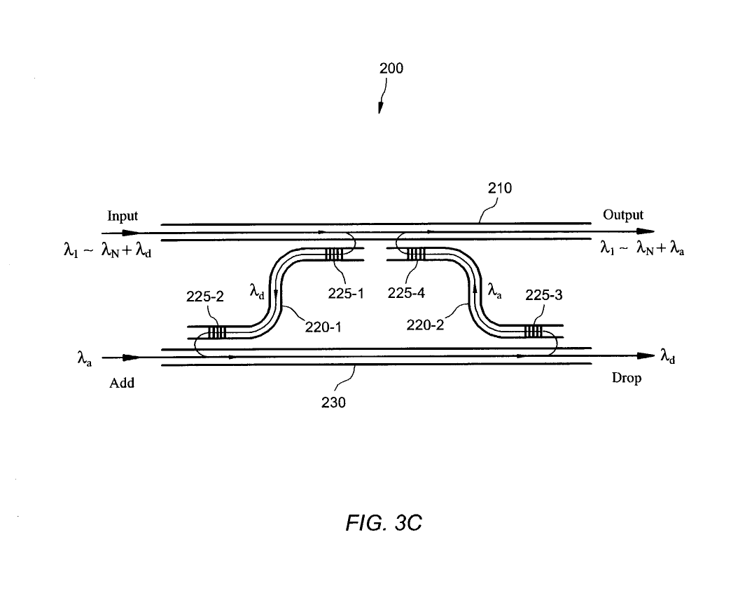

FIG. 3A shows structure of an “S” type switch. A wavelength selective bridge waveguide 220 is coupled between a bus waveguide 210 and a second waveguide 230. A multiplexed optical signal is transmitted in a bus waveguide 210 over N multiplexed wavelengths λ₁, λ₂, λ₃, . . . , λ_{N}, where N is a positive integer. The wavelength selective bridge waveguide 220 has a first set of Bragg gratings disposed on a first “bridge on-ramp segment” 225-1 for coupling to the bus waveguide 210. An optical signal with a central wavelength λᵢ particular to the Bragg gratings 225 disposed on the bridge waveguide 220 is guided through the first bridge ramp segment 225-1 to be reflected into the wavelength selective bridge waveguide 220. The remainder optical signal of the wavelengths λ₁, λ₂, . . . , λᵢ₋₁, λᵢ₊₁, . . . , λ_{N} is not affected and continues to transmit over the waveguide 210. The Bragg gratings 225 have a specific pitch for reflecting the optical signal of the selected wavelength λᵢ onto the wavelength selective bridge waveguide 220. The wavelength selective bridge waveguide 220 further has a second set of Bragg gratings as a bridge off-ramp segment 225-2 coupled to an outbound waveguide 230. The second set of Bragg gratings has a same pitch as the first set of Bragg gratings. The selected wavelength λᵢ is guided through the bridge off-ramp segment 225-2 to be reflected and coupled into the outbound waveguide 230. The bridge off-ramp segment 225-2 is disposed at a distance from the bridge on-ramp segment 225-1. The bridge waveguide 220 can be an optical fiber, waveguide or other optical transmission medium connected between the bridge on-ramp segment 225-1 and the bridge off-ramp segment 225-2.

FIG. 3B shows another structure of “S” type switches. A wavelength selective bridge waveguide 220′ is coupled between a bus waveguide 210 and a second waveguide 230′. A multiplexed optical signal is transmitted in a bus waveguide 210 over N multiplexed wavelengths λ₁, λ₂, λ₃, . . . , λ_{N}, where N is a positive integer. The wavelength selective bridge waveguide 220′ has a first set of Bragg gratings disposed on a first “bridge on-ramp segment” 225-1 for coupling to the bus waveguide 210. An optical signal with a central wavelength λᵢ particular to the Bragg gratings 225-1 disposed on the bridge waveguide 220′ is guided through the first bridge ramp segment 225-1 to be reflected into the wavelength selective bridge waveguide 220′. The remainder optical signal of the wavelengths λ₁, λ₂, . . . , λᵢ₋₁, λᵢ₊₁, . . . , λ_{N} is not affected and continues to transmit over the waveguide 210. The Bragg gratings 225-1 have a specific pitch for reflecting the optical signal of the selected wavelength λᵢ into the wavelength selective bridge waveguide 220′. The wavelength selective bridge waveguide 220′ further has a bridge off-ramp segment 225-2′ coupled to an outbound waveguide 230′ near a section 235 of the outbound waveguide 230. The section 235 on the outbound waveguide 230′ has a second set of Bragg gratings having a same pitch as the first set of Bragg gratings. The bridge off-ramp segment 225-2′ is disposed at a distance from the bridge on-ramp segment 225-1. The bridge waveguide 220 can be an optical fiber, waveguide or other optical transmission medium connected between the bridge on-ramp segment 225-1 and the bridge off-ramp segment 225-2′.

FIG. 3C shows a simple add/drop device that uses two “S” type switches. A wavelength selective bridge waveguide 220-1 is coupled between a bus waveguide 210 and a second waveguide 230. A multiplexed optical signal is transmitted in a bus waveguide 210 over N+1 multiplexed wavelengths λ₁, λ₂, λ₃, . . . , λ_{N}, λ_{d}, where N is a positive integer. The wavelength selective bridge waveguide 220-1 has a first set of Bragg gratings disposed on a first “bridge on-ramp segment” 225-1 for coupling to the bus waveguide 210. An optical signal with a central wavelength λ_{d} particular to the Bragg gratings 225-1 disposed on the bridge waveguide 220-1 is guided through the first bridge ramp segment 225-1 to be reflected into the wavelength selective bridge waveguide 220-1. The remaining optical signal of the wavelengths λ₁, λ₂, . . . , λ_{N} is not affected and continues to transmit over the waveguide 210.

The Bragg gratings 225-1 have a specific pitch for reflecting the optical signal of the selected wavelength λ_{d} into the wavelength selective bridge waveguide 220-1. The wavelength selective bridge waveguide 220-1 further has a bridge off-ramp segment 225-2 coupled to second waveguide 230. The bridge off-ramp segment 225-2 has a second set of Bragg gratings having a same pitch as the first set of Bragg gratings. The bridge off-ramp segment 225-2 is disposed at a distance from the bridge on-ramp segment 225-1. The bridge waveguide 220 can be an optical fiber, waveguide or other optical transmission medium connected between the bridge on-ramp segment 225-1 and the bridge off-ramp segment 225-2. Using the bridge off-ramp segment 225-2, the optical signal λ_{d} can be dropped.

Further, a wavelength selective bridge waveguide 220-2 is coupled between the bus waveguide 210 and second waveguide 230. An optical signal to be added λₐ progagates along the second waveguide 230. The wavelength selective bridge waveguide 220-2 has a first set of Bragg gratings disposed on a first “bridge on-ramp segment” 225-3 for coupling the optical signal λₐ to the bridge waveguide 220-2. The optical signal λₐ is guided through the bridge ramp segment 225-3 to be reflected into the input waveguide 210 by a bridge off-ramp segment 225-4.

The Bragg gratings on the bridge off-ramp segmen 225-4 have a specific pitch for reflecting the optical signal of the selected wavelength λₐ into the input waveguide 210. The bridge waveguide 220-2 can be an optical fiber, waveguide or other optical transmission medium connected between the bridge on-ramp segment 225-3 and the bridge off-ramp segment 225-4. Using the bridge off-ramp segment 225-4, the optical signal λₐ can be added.

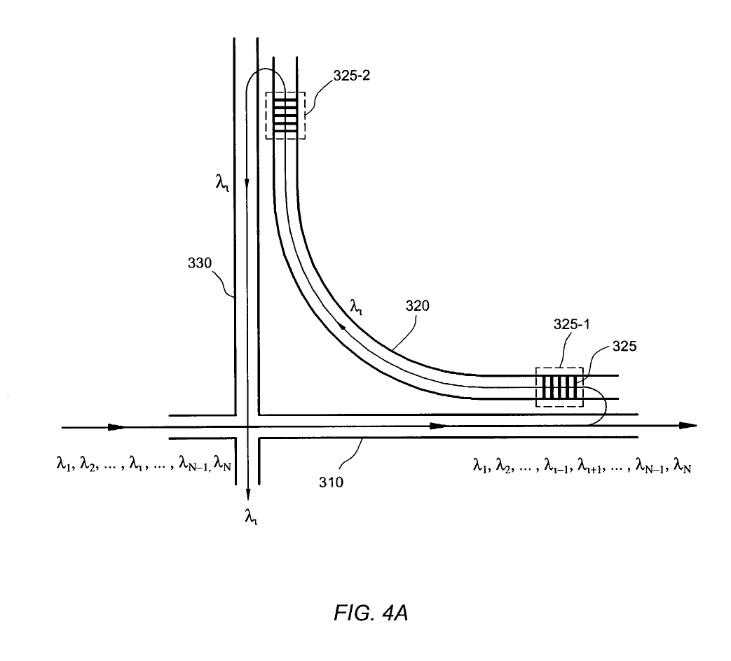

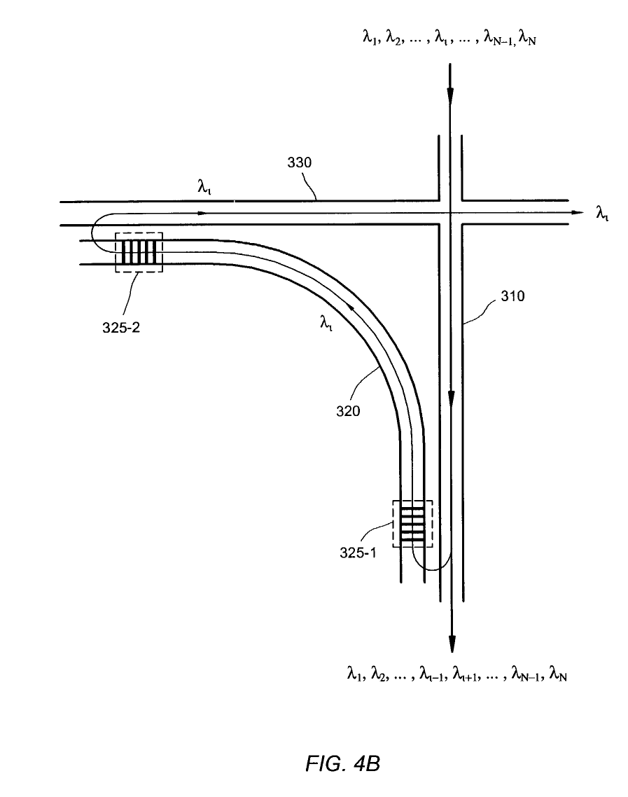

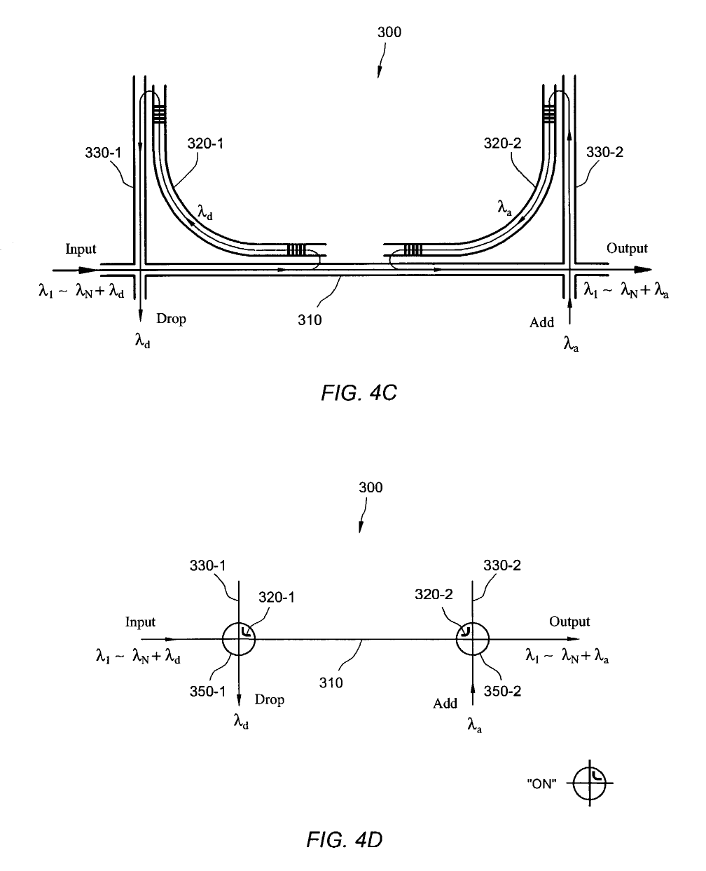

FIG. 4A shows structure of an “L” type switch. A wavelength selective bridge waveguide 320 is coupled between a bus waveguide 310 and an intersecting waveguide 330. Note that the intersecting waveguide 330 may be “physically” intersecting, i.e., sharing the same physical waveguide at the intersection point. However, in other embodiments, the intersecting waveguide 330 may be intersecting in the sense that it crosses over or below the bus waveuide 310. Thus, the term intersecting as used herein is meant to mean crossing over, crossing under, or physically intersecting.

A multiplexed optical signal is transmitted in a bus waveguide 310 over N multiplexed wavelengths λ₁, λ₂, λ₃, . . . , λ_{N}, where N is a positive integer. The wavelength selective bridge waveguide 320 has a first set of Bragg gratings disposed on a first “bridge on-ramp segment” 325-1 for coupling to the bus waveguide 310. An optical signal with a central wavelength λᵢ particular to the Bragg gratings 325 disposed on the bridge waveguide 320 is guided through the first bridge ramp segment 325-1 to be reflected into the wavelength selective bridge waveguide 320. The remainder optical signal of the wavelengths λ₁, λ₂, . . . , λᵢ₋₁, λᵢ₊₁, . . . , λ_{N} is not affected and continues to transmit over the waveguide 310. The Bragg gratings 325 have a specific pitch for reflecting the optical signal of the selected wavelength λ₁ into the wavelength selective bridge waveguide 320. The wavelength selective bridge waveguide 320 further has a second set of Bragg gratings 325 as a bridge off-ramp segment 325-2 coupled to an outbound waveguide 330. The bridge off-ramp segment 325-2 is disposed at a distance from the bridge on-ramp segment 325-1. The bridge waveguide 320 can be an optical fiber, waveguide or other optical transmission medium connected between the bridge on-ramp segment and the bridge off-ramp segment 325-2.

FIG. 4B shows another structure of “L” type switches. This structure is similar to that shown in FIG. 4A with the bus waveguide 310 disposed in a vertical direction and an intersecting outbound waveguide 330 disposed along a horizontal direction.

FIG. 4C shows an add/drop device disclosed in this invention, which is constructed by two L-type switches. The add/drop device 300 consists of a bus waveguide 310, an outbound waveguide 330-1, an inbound waveguide 330-2, and two bridge waveguides 320-1 and 320-2.

The bridge waveguide 320-1 has Bragg gratings formed on both ends of the waveguide that are adjacent the outbound waveguide 330-1 and the bus waveguide 310. The Bragg gratings on the bridge waveguide 320-1 have a periodicity adapted to reflect a drop wavelength λ_{d}. Similarly, the bridge waveguide 320-2 has Bragg gratings formed on both ends of the waveguide that are adjacent the inbound waveguide 330-2 and the bus waveguide 310. The Bragg gratings on the bridge waveguide 320-2 have a periodicity adapted to reflect an add wavelength λₐ.

The add/drop device 300 operates as a compact optical add/drop device. Assume that the bus waveguide 310 carries a multiplexed optical signal having wavelength channels of λ₁, λ₂, . . . , λ_{N}, λ_{d}, then the optical signal with its central wavelength λ_{d} particular to the Bragg gratings of bridge waveguide 320-1 is coupled into the bridge waveguide 320-1 and further coupled into outbound waveguide 330-1. As a result, the wavelength channel λ_{d} is extracted or “dropped” from the input terminal of bus waveguide 310 to the output terminal of outbound waveguide 330-1. The remaining optical signal of the wavelength channels λ₁, λ₂, . . . , λ_{N} is not affected and continues propagating along the bus waveguide 310.

Similarly, a wavelength channel λₐ propagating along inbound waveguide 330-2 is coupled into bridge waveguide 320-2 and then coupled into bus waveguide 310 and is transmitted towards the output end of bus waveguide 310. As a result, wavelength channel λₐ is “added” from inbound waveguide 330-2 to output terminal of bus waveguide 310. This simple structure, constructed by two L-type switches, demonstrates its inherent simplicity of constructing an add/drop device that requires neither demultiplexers nor multiplexers.

FIG. 4D shows a symbolic diagram of the structure shown in FIG. 4C and will be used later to illustrate other more complex structures. The building block of L-type wavelength selective switch is symbolized as an “L” around the intersection of two waveguides. The circles 350-1 and 350-2 denote the L-type wavelength selective switches are in the “on” position.

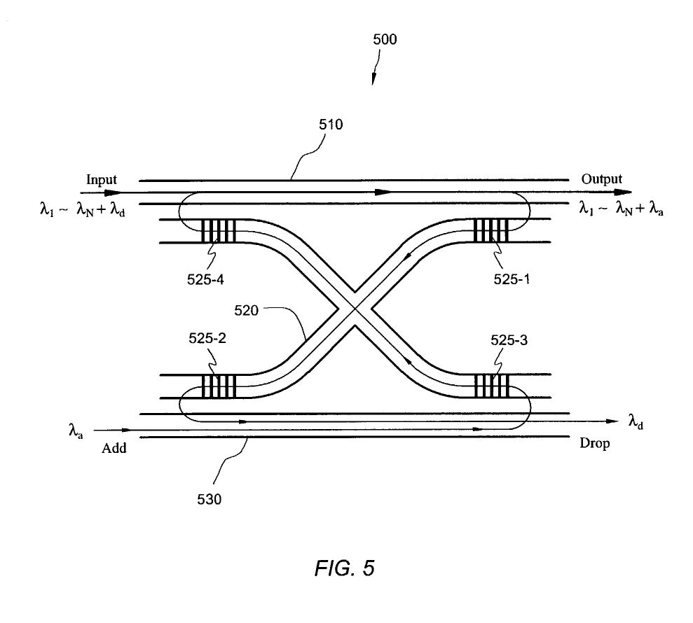

FIG. 5 shows an X-type switch 500 that can serve as an add/drop device. The structure 500 consists of a bus waveguide 510, a second waveguide 530, and a bridge waveguides 520, which forms a cross-type waveguide with four Bragg gratings segments 525-1, 525-2, 525-3, and 525-4. With Bragg gratings 525-1 and 525-2 set to drop wavelength λ_{d} and Bragg gratings 525-3 and 525-4 set to add wavelength λₐ, this structure 501 performs as a compact add/drop device.

Assuming that the bus waveguide 510 carries a multiplexed optical signal of wavelength channels λ₁, λ₂, . . . , λ_{N}+λ_{d}, then the optical signal with its central wavelength λ_{d} particular to Bragg gratings 525-1 is coupled into the wavelength selective bridge waveguide 520 by Bragg gratings 525-1 and then coupled again into the second waveguide 530 by Bragg gratings 525-2. Therefore, the wavelength channel λ_{d} is extracted or “dropped” from bus waveguide 510 to the second waveguide 530. The remaining wavelength channels λ₁, λ₂, . . . , λ_{N} are not affected and continues to propagate through the waveguide 510.

Similarly, a wavelength channel λₐ transmitting along second waveguide 530 is coupled into bridge waveguides 520 by Bragg gratings 525-3 and then coupled into bus waveguide 510 by Bragg gratings 525-4 and is transmitted towards the output end of bus waveguide 510. As a result, wavelength channel λ_{d} is dropped and wavelength channel λₐ is added. This structure demonstrates its inherent simplicity of constructing an add/drop device—requiring neither demultiplexers nor multiplexers. Note that the Bragg grating 525-1 is “downstream” from Bragg grating 525-4.

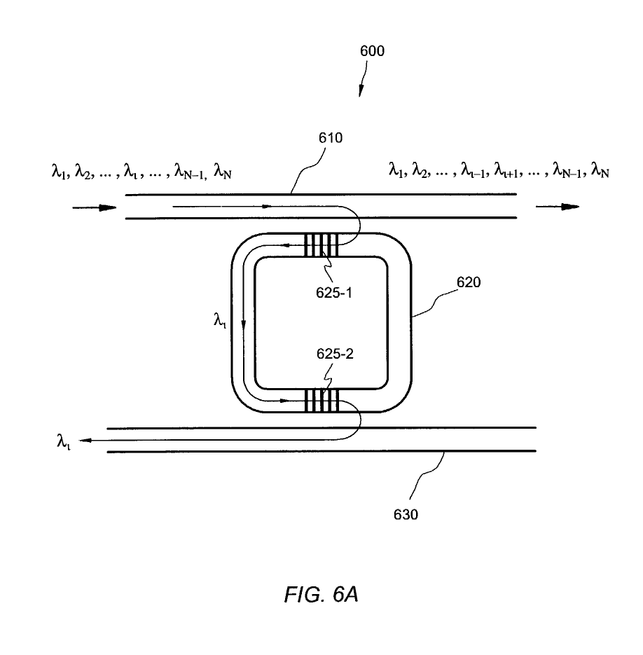

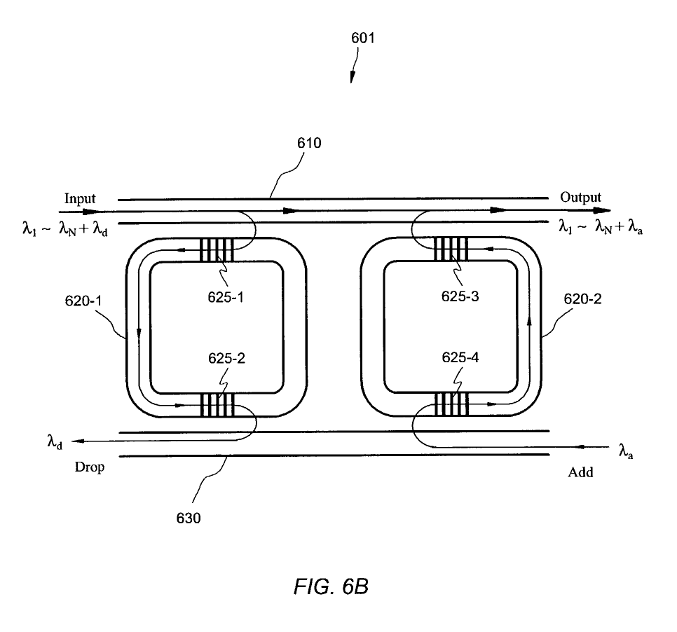

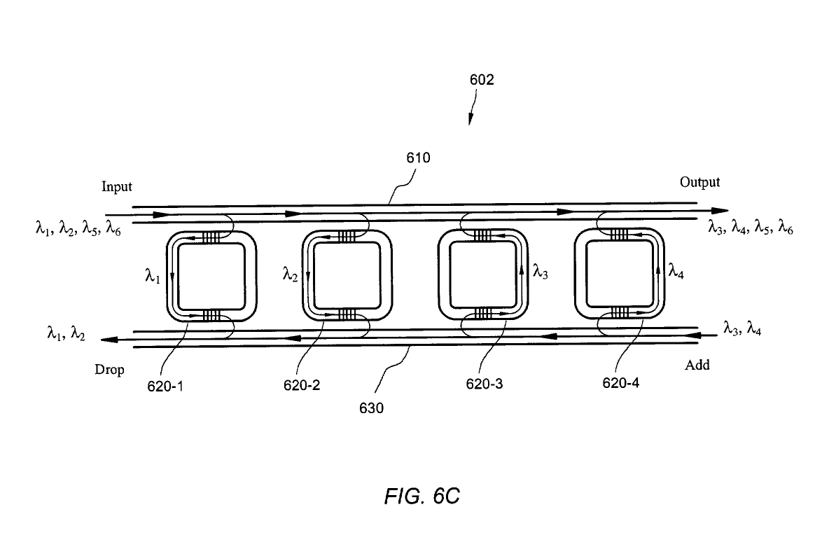

FIG. 6A shows an O-type switch that uses a closed-loop wavelength selective bridge waveguide 620 coupled between a bus waveguide 610 and a second waveguide 630. A multiplexed optical signal is transmitted in a bus waveguide 610 over N multiplexed wavelengths λ₁, λ₂, . . . , λᵢ₋₁, λᵢ, λᵢ₊₁, . . . , λ_{N} where N is a positive integer. The wavelength selective bridge waveguide 620 has a first set of Bragg gratings 625-1 for coupling to the bus waveguide 610. An optical signal with a central wavelength λᵢ particular to the Bragg gratings 625-1 propagating on the bus waveguide 610 is guided through the first Bragg gratings 625-1 segment and is reflected into the wavelength selective bridge waveguide 620.

The remainder optical signal of the wavelengths λ₁, λ₂, . . . , λᵢ₋₁, λᵢ₊₁, . . . , λ_{N} is not affected and continues to transmit over the waveguide 610. The Bragg gratings 625-1 have a specific pitch for reflecting the optical signal of the selected wavelength λᵢ onto the wavelength selective bridge waveguide 620. The wavelength selective bridge waveguide 620 further has a second set of Bragg gratings 625-2 to couple λᵢ into an outbound waveguide 630. The second set of Bragg gratings 625-2 is disposed at a distance from the first Bragg gratings 625-1. The bridge waveguide 620 can be an optical fiber, waveguide or other optical transmission medium connected between first Bragg gratings 625-1 and second Bragg gratings 625-2.

FIG. 6B shows an add/drop device constructed with two O-type switches described in FIG. 6A. Two closed-loop wavelength selective bridge waveguides 620-1 and 620-2 are coupled between a bus waveguide 610 and a second waveguide 630. With Bragg gratings 625-1 and 625-2 set to drop wavelength λ_{d} and Bragg gratings 625-3 and 625-4 set to add wavelength λₐ, this structure 601 can perform as an add/drop device.

Similar to the operating functions described above for FIG. 6A, a multiplexed optical signal is transmitted in a bus waveguide 610 over N+1 multiplexed wavelengths λ₁, λ₂, . . . , λ_{N}+λ_{d}, where N is a positive integer. The optical signal with a central wavelength λ_{d} particular to the Bragg gratings 625-1 disposed on the bus waveguide 610 is guided through the first Bragg gratings 625-1 segment and is reflected into the wavelength selective bridge waveguide 620. The remaining optical signals of wavelengths λ₁, λ₂, . . . , λ_{N} are not affected and continue to transmit over the waveguide 610. Using the Bragg gratings 625-2, the optical signal λ_{d} can be dropped.

With the addition of bridge waveguide 620-2, the wavelength λₐ transmitting along second waveguide 630 can be coupled into bridge waveguide 620-2 by Bragg gratings 625-4 and then coupled into bus waveguide 610 by Bragg gratings 625-3. Thus the wavelength λₐ can be added. This structure is a simple add/drop device—requiring neither demultiplexers nor multiplexers.

FIG. 6C further illustrates capability of structure expansion of add/drop devices based on O-type switches. This add/drop device 602 consists of a bus waveguide 610, a second waveguide 630, and four bridge waveguides 620-1, 620-2, 620-3, and 620-4, which have their Bragg gratings set to λ₁, λ₂, λ₃, and λ₄, respectively. With multiplexed wavelengths λ₁, λ₂, λ₅, λ₆ provided as input into the input terminal of bus waveguide 610, bridge waveguides 620-1 and 620-2 extract or “drop” wavelengths λ₁, λ₂ to the second waveguide 630.

Similarly, bridge waveguides 620-3 and 620-4 inject or “add” wavelengths λ₃, λ₄ traveling along the second waveguide 630 to bus waveguide 610. The optical signals exiting from the output terminal of bus waveguide 610 are λ₃, λ₄, λ₅, λ₆, which are the combination of the remaining input signals λ₅, λ₆ and the added signals λ₃, λ₄. Further expansion can be achieved by adding more bridge waveguides between bus waveguide 610 and the second waveguide 630.

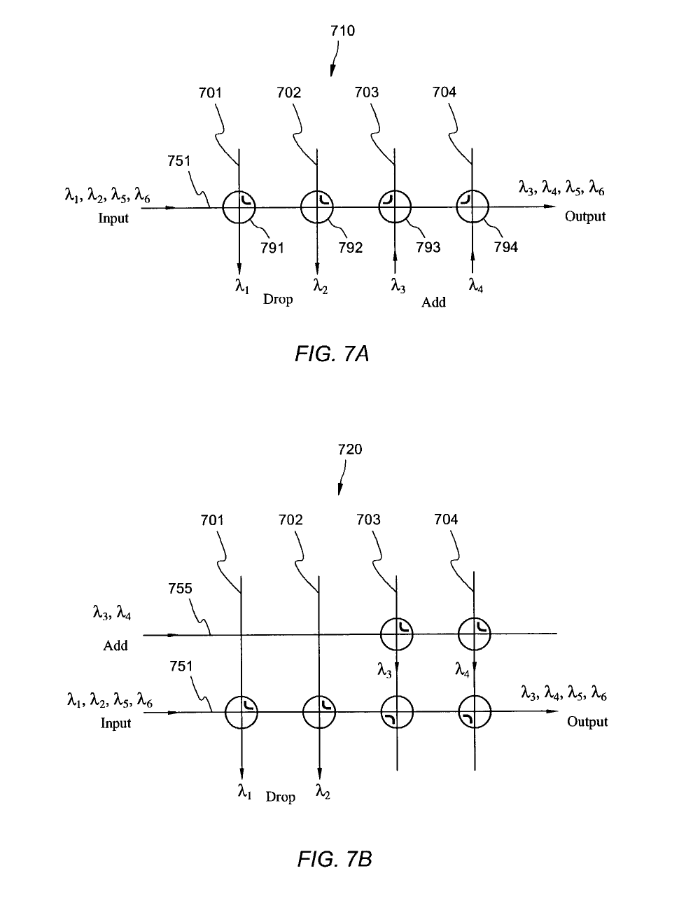

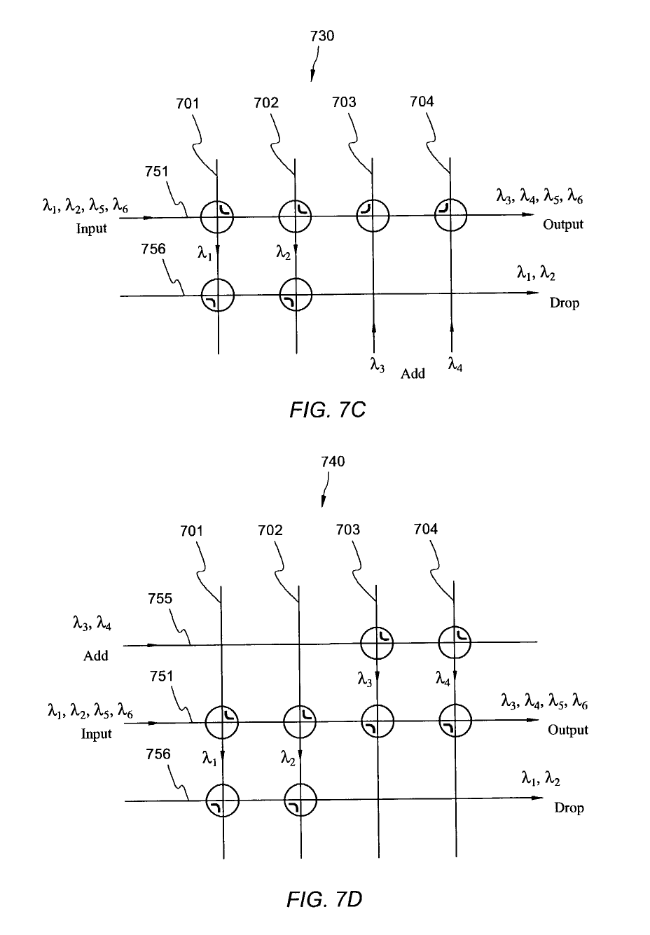

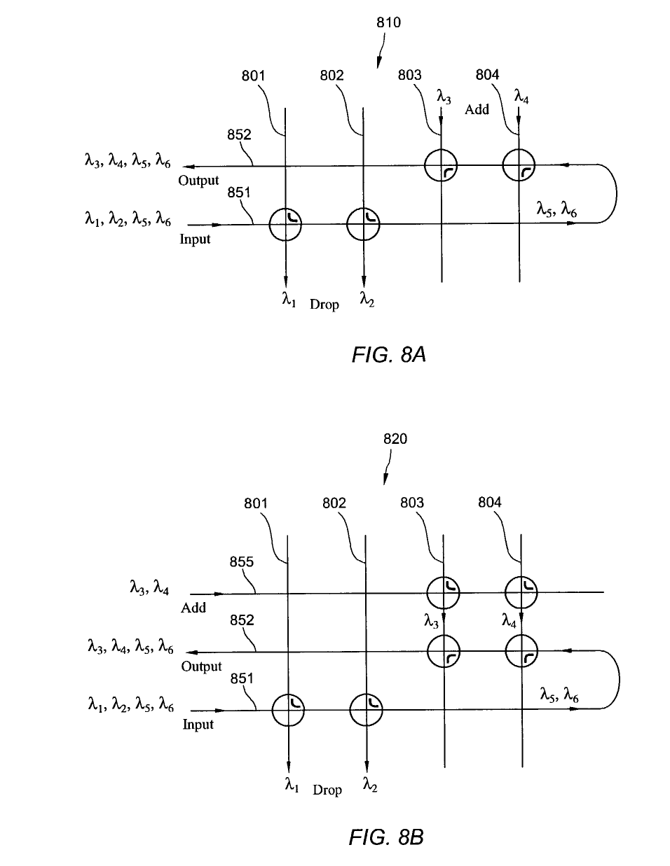

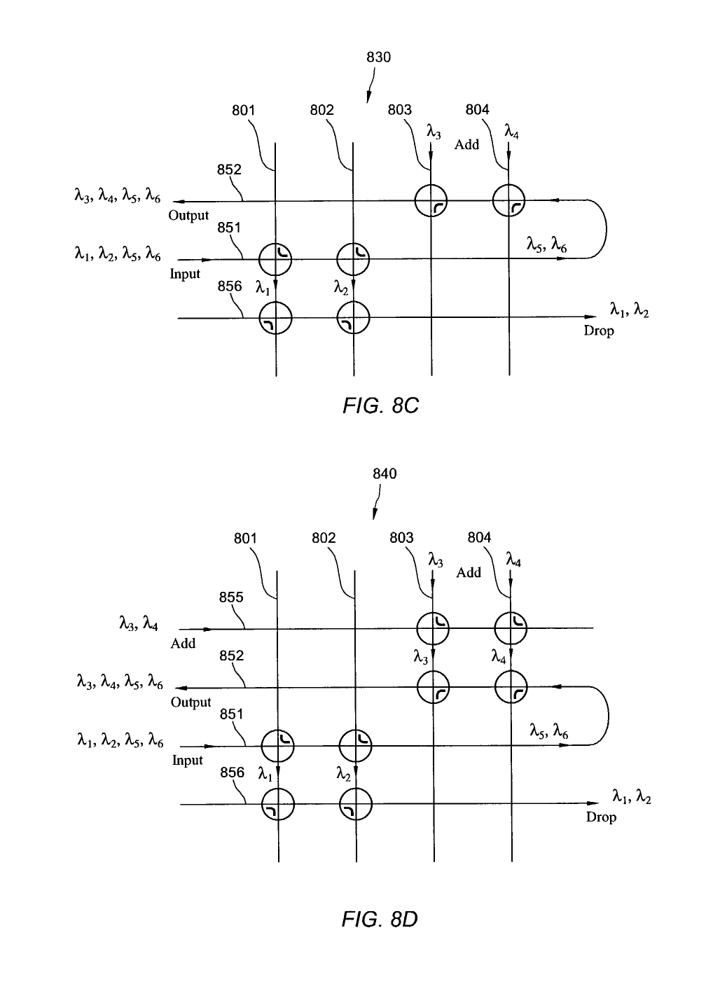

For simplicity of illustrations FIGS. 7A to 8D show only exemplary wavelengths λ₁, λ₂, λ₃, λ₄, λ₅, λ₆, instead of generalized N wavelengths λ₁, λ₂, λ₃, . . . , λ_{N}. Similarly, these illustrative drawings show only exemplary waveguides of the same type in a given structure, instead of generalized N waveguides.

FIG. 7A shows in symbolic form an embodiment of the present invention. An add/drop device 710 can be constructed by combining four L-type switches, which are detailed in FIG. 4A. The add/drop device 710 comprises a bus waveguide 751 and another four waveguides 701, 702, 703, and 704. The add/drop device 710 further includes four L-type wavelength selective switches 791, 792, 793, and 794 located at the intersections between bus waveguide 751 and waveguides 701, 702, 703, and 704, in which the Bragg gratings inside the L-type wavelength selective switches 791, 792, 793, and 794 are preset to wavelength λ₁, λ₂, λ₃, and λ₄, respectively. Similar operation principles as described previously for the add/drop device shown in FIGS. 4C and 4D apply to the add/drop device 710.

With multiplexed input optical signal consisting of wavelength channels λ₁, λ₂, λ₅, λ₆ provided into input terminal of bus waveguide 751, L-type wavelength selective switches 791 and 792 extract or “drop” wavelength channels λ₁ and λ₂ to the waveguides 701 and 702, respectively. Similarly, L-type wavelength selective switches 793 and 794 inject or “add” wavelengths channels λ₃ and λ₄ to the bus waveguide 751, respectively.

As a result, the optical signals exit from the output terminal of bus waveguide 751 are λ₃, λ₄, λ₅, λ₆, which are the combination of the remainder of the input signals λ₅, λ₆ and the added signals λ₃, λ₄. Further expansion is achieved by adding more waveguides and associated L-type wavelength selective switches accordingly.

Additional embodiments of add/drop devices employing L-type wavelength selective switches are shown in FIGS. 7B, 7C, and 7D. In FIG. 7B, an add/drop device 720 is constructed by adding an add waveguide 755 and two associated L-type wavelength selective switches to the add/drop device 710 disclosed in FIG. 7A. Same basic operation principles as described previously for the add/drop device shown in FIGS. 4C and 4D apply to this add/drop device 720. With the addition of add waveguide 755, add wavelength channels λ₃ and λ₄ now come from the same input terminal of waveguide 755.

In FIG. 7C, an add/drop device 730 is constructed by adding a drop waveguide 756 and two associated L-type wavelength selective switches to the add/drop device 710 disclosed in FIG. 7A. With the addition of drop waveguide 756, drop wavelength channels λ₁ and λ₂ are extracted to the output terminal of waveguide 756.

In FIG. 7D, an add/drop device 740 is constructed by adding both a drop waveguide 756 and an add waveguide 755 to the add/drop device disclosed in FIG. 7A. With the addition of both drop waveguide 756 and add waveguide 755, drop wavelength channels λ₁ and λ₂ and add wavelength channels λ₃ and λ₄ will appear at drop and add terminals, respectively.

FIGS. 8A, 8B, 8C, and 8D shows alternative embodiments of add/drop devices. In FIG. 8A, based on the structure 710 disclosed in FIG. 7A, an add/drop device is constructed by connecting two waveguides 851 and 852 to form a U-type waveguide. The function and the number of L-type wavelength selective switches required in this add/drop device 810 is identical to the add/drop device 710 in FIG. 7A. Basically, the addition of the structure 810 provides flexibility for manufacturing and integration. Similarly, the add/drop devices 820, 830, and 840 disclosed in FIGS. 8B, 8C and 8D respectively are alternative embodiments with U-type waveguide to the add/drop devices 720, 730, and 740 disclosed in FIGS. 7B, 7C and 7D respectively.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. An apparatus for adding and dropping optical signals from an input waveguide, said input waveguide carrying a plurality of wavelength channels including a drop wavelength channel, said apparatus comprising:
an output waveguide carrying an add wavelength channel;
a drop bridge waveguide having drop Bragg gratings formed on a first end and a second end, said drop Bragg gratings having a periodicity matched to said drop wavelength channel, said first end proximal to said input waveguide and said second end proximal to said output waveguide; and
an add bridge waveguide having add Bragg gratings formed on a first end and a second end, said add Bragg gratings having a periodicity matched to said add wavelength channel, said first end proximal to said input waveguide and said second end proximal to said output waveguide.

2. The apparatus of claim 1 wherein said drop bridge waveguide and said add bridge waveguide intersect to form an X-type switch.

3. The apparatus of claim 1 wherein said plurality of wavelength channels travel in a first direction along said input waveguide and said first end of said drop bridge waveguide is upstream from said first end of said add bridge waveguide.

4. The apparatus of claim 3 wherein said add wavelength channels travel along said output waveguide in a first direction and said second end of said add bridge waveguide is upstream from said second end of said drop bridge waveguide.

5. An apparatus for dropping optical signals from an input waveguide, said input waveguide carrying a plurality of wavelength channels including a drop wavelength channel, said apparatus comprising:
an output waveguide; and
a drop bridge waveguide formed as a closed loop waveguide disposed between said input waveguide and said output waveguide, said drop bridge waveguide having drop Bragg gratings formed on a first side and a second side, said drop Bragg gratings having a periodicity matched to said drop wavelength channel, said first side proximal to said input waveguide and said second side proximal to said output waveguide.

6. The apparatus of claim 5 further adapted for injecting an add wavelength channel to said input waveguide, said apparatus further including an add bridge waveguide as a closed loop waveguide disposed between said input waveguide and said output waveguide, said add bridge waveguide having add Bragg gratings formed on a first side and a second side, said add Bragg gratings having a periodicity matched to said add wavelength channel, said first side proximal to said input waveguide and said second side proximal to said output waveguide, said output waveguide carrying said add wavelength channel.

7. The apparatus of claim 5 further including additional closed loop drop bridge waveguides disposed between said input waveguide and said output waveguide, said each one of said additional closed loop drop bridge waveguides having formed thereon drop Bragg gratings adapted to the periodicity of one of said plurality of wavelength channels.

8. The apparatus of claim 6 further including additional closed loop drop bridge waveguides disposed between said input waveguide and said output waveguide, said each one of said additional closed loop drop bridge waveguides having formed thereon drop Bragg gratings adapted to the periodicity of one of said plurality of wavelength channels.

9. The apparatus of claim 8 further including additional closed loop add bridge waveguides disposed between said input waveguide and said output waveguide, said each one of said additional closed loop add bridge waveguides having formed thereon add Bragg gratings adapted to the periodicity of additional add wavelength channels.

10. An apparatus for adding optical signals to an input waveguide, said input waveguide carrying a plurality of wavelength channels, said apparatus comprising:
an output waveguide carrying an add wavelength channel; and
an add bridge waveguide formed as a closed loop waveguide disposed between said input waveguide and said output waveguide, said add bridge waveguide having add Bragg gratings formed on a first side and a second side, said add Bragg gratings having a periodicity matched to said add wavelength channel, said first side proximal to said input waveguide and said second side proximal to said output waveguide.

11. An apparatus for adding and dropping multiple optical signals from an input waveguide, said input waveguide carrying a plurality of wavelength channels including a plurality of drop wavelength channels, said apparatus comprising:
an output waveguide carrying a plurality of add wavelength channels; and
a plurality of X-type switches placed between said output waveguide and said input waveguide, each of said plurality of X-type switches comprising:
(a) a drop bridge waveguide having drop Bragg gratings formed on a first end and a second end, said drop Bragg gratings having a periodicity matched to one of said plurality of drop wavelength channels, said first end proximal to said input waveguide and said second end proximal to said output waveguide; and
(b) an add bridge waveguide having add Bragg gratings formed on a first end and a second end, said add Bragg gratings having a periodicity matched to one of said plurality of add wavelength channels, said first end proximal to said input waveguide and said second end proximal to said output waveguide, said add bridge waveguide intersecting with said drop bridge waveguide.

12. The apparatus of claim 11 wherein said X-type switches are arranged serially along said input waveguide.

13. An apparatus for adding to and dropping from an input waveguide, said input waveguide carrying a plurality of wavelength channels including a drop wavelength channel, said apparatus comprising:
a drop waveguide intersecting with said input waveguide;
a drop bridge waveguide having drop Bragg gratings formed on a first end and a second end, said drop Bragg gratings having a periodicity matched to said drop wavelength channel, said first end proximal to said input waveguide and said second end proximal to said drop waveguide;
an add waveguide intersecting with said input waveguide and carrying an add wavelength channel; and
an add bridge waveguide having add Bragg gratings formed on a first end and a second end, said add Bragg gratings having a periodicity matched to said add wavelength channel, said first end proximal to said input waveguide and said second end proximal to said add waveguide.

14. The apparatus of claim 13 further including
a second drop waveguide intersecting with said input waveguide;
a second drop bridge waveguide having drop Bragg gratings formed on a first end and a second end, said drop Bragg gratings having a periodicity matched to a second drop wavelength channel carried in said input waveguide, said first end proximal to said input waveguide and said second end proximal to said drop waveguide;
a second add waveguide intersecting with said input waveguide and carrying a second add wavelength channel; and
a second add bridge waveguide having add Bragg gratings formed on a first end and a second end, said add Bragg gratings having a periodicity matched to said second add wavelength channel, said first end proximal to said input waveguide and said second end proximal to said second add waveguide.
